(19) United States
(12) Patent Application Publication
(10) Pub. No.: US 2007/0126729 A1
(43) Pub. Date: Jun. 7, 2007

(54) Method and apparatus for reducing power consumption in display area

(75) Inventors: Sung-min Yoon, Seoul (KR); Yong-hoon Lee, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Ltd., Co., Suwon-si (KR)

(21) Appl. No.: 11/589,043

(22) Filed: Oct. 30, 2006

(30) Foreign Application Priority Data
Nov. 18, 2005 (KR) 2005-110929

(51) Int. Cl. G09G 5/00

(52) U.S. Cl. 345/211

(57) ABSTRACT

A method and apparatus for reducing power consumption in a display area of an electronic device such as a portable computer are provided. Such a method includes: (a) activating a mode of setting the display area to a white background screen using a first input command of a user; and (b) locating the white background screen over all windows, except for a current task window being displayed in part of the display area. Additionally, the apparatus for reducing power consumption in a display area includes an input unit receiving a first input command from a user; a mode activation unit for activating a mode of setting the display area to a white background screen according to a first input command from a user; and a location setting unit for locating the white background screen over all windows, except for a current task window being displayed in part of the display area. As a result, the lifetime of a battery of a portable computer is maximized by reducing power consumption in the portion of a display area that is not being used by a user.

### CROSS-REFERENCE TO RELATED APPLICATIONS

This application claims all benefits accruing under 35 U.S.C. §119 from Korean Application No. 2005-110929 filed on Nov. 18, 2005 in the Korean Intellectual Property Office, the disclosure of which is incorporated herein by reference.

### BACKGROUND OF THE INVENTION

1. Field of the Invention

The present invention relates to a method and apparatus for reducing power consumption in a display area, and more particularly, to a method and apparatus for reducing power consumption in a display area of an electronic device, which covers all windows, except for a current task window that is being displayed on part of a display area, with a white background screen, and which locates the current task window on the white background screen, so as to reduce power consumption in the display area.

2. Related Art

Generally, an electronic device, such as a computer system, comprises a display panel to provide a visual display of an image, and a computer main body which supports the display panel and is mounted with a variety of hardware devices, such as a microprocessor, a video chip, a hard disk drive (e.g., a CD-ROM drive, a DVD drive, a HD-DVD drive, and a Blu-Ray drive), memory devices and a power supply device configured to supply power to the main body and the display panel. Such a computer system is generally a portable computer, such as a laptop computer, a notebook computer, a palmtop computer, a personal digital assistant (PDA), and a mobile device etc. Such a portable computer has a smaller volume and better portability than a desktop computer. As a result, portable computers are widely used by users who frequently travel.

Such a portable computer is supplied with power, via a direct-current (DC) power adapter, or alternatively, power from a battery. However, when the battery is used, there is a limitation in the charge capacity of the battery. As a result, it is difficult to use the portable computer for a long time. Therefore, in order to reduce power consumption, a variety of methods of managing power using software or hardware have been proposed. For example, a common power management method is switching the state of power consumption to a low power consumption mode or a hibernation mode, when no signal has been input into the computer system for a predetermined time. Another example method requires installing a power control mode switching unit for controlling power consumption by manually operating the power control mode switching unit.

FIG. 1 illustrates yet another power saving technique in which a current task window is activated on a display area. As shown in FIG. 1, a plurality of windows supporting multi-tasking are displayed on the task bar of a window desktop 10 on the display panel of a portable computer. Typically, a user selects only a current task window 20 from among the plurality of windows and performs a particular task. That is, the user may execute a plurality of windows, but the number of windows on which a task is actually performed is only one at any given moment. Therefore, there is a problem in that power is consumed in the areas of inactive windows in which tasks are not executed the same as in the area of an active current task window in which a task is executed.

### SUMMARY OF THE INVENTION

Several aspects and example embodiments of the present invention provide a method and apparatus for reducing power consumption in a display area which can reduce power consumption in the portion of the display area that is not used by a user.

Additional aspects and/or advantages of the invention will be set forth in part in the description which follows and, in part, will be obvious from the description, or may be learned by practice of the invention.

In accordance with an embodiment of the present invention, a method of reducing power consumption in a display area, comprises: (a) activating a mode of setting the display area to a white background screen using a first input command of a user; and (b) locating the white background screen over all windows, except for a current task window that is being displayed in part of the display area.

According to an aspect of the present invention, such a method further comprises previously storing information about the current task window. Such information comprises a handle value, a z-order value, and a size and location of the current task window.

According to another aspect of the present invention, such a method further comprises setting a z-order value of the white background screen to a value which is lower than that of the current task window and is higher than the z-order values of remaining windows other than the current task window.

According to another aspect of the present invention, such a method further comprises hiding the white background screen by restoring the information about the current task window, when the mode is deactivated by a second input command of the user.

In accordance with another embodiment of the present invention, an apparatus for reducing power consumption in a display area of an electronic device is provided with an input unit for receiving a first input command from a user; a mode activation unit for activating a power saving mode of the electronic device to set the display area to a white background screen according to the first input command from a user, via the input unit; and a location setting unit for locating the white background screen to cover all windows on the display area, except for a current task window that is being displayed in part of the display area.

In accordance with yet another embodiment of the present invention, there is provided a computer-readable recording medium comprising instructions that, when executed by a computer system, perform the method comprising: activating a power saving mode of the computer system to set a display area of a display panel to a white background screen in response to an input command from a user; and locating the white background screen to cover all windows and window icons on the display area of the display panel, except for a current task window that is being displayed in part of the display area of the display panel.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a diagram illustrating an example state in which a current task window is activated in a display area of a display panel;

FIG. 2 is a diagram illustrating a process of operating an apparatus for reducing power consumption in a display area of a display panel according to an embodiment of the present invention;

FIG. 3 is a block diagram illustrating the overall construction of an apparatus for reducing power consumption in a display area of a display panel according to the embodiment of the present invention;

FIG. 4 is a flowchart illustrating a method of reducing power consumption in a display area of a display panel according to an embodiment of the present invention; and

FIGS. 5A-5B are diagrams illustrating the comparison of power consumption depending upon colors of a display area of a display panel.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A portable computer to which embodiments of the present invention can be applied includes all computers capable of being carried, such as a laptop computer, a notebook computer and a palmtop computer.

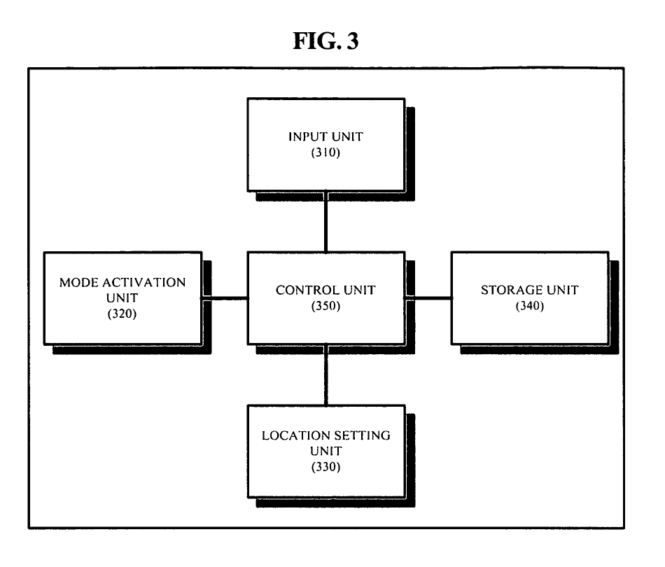

FIG. 3 is a block diagram illustrating the overall construction of an apparatus for reducing power consumption in a display area according to an embodiment of the present invention. Referring to FIG. 3, the apparatus for reducing power consumption includes an input unit 310, a mode activation unit 320, a location setting unit 330, a storage unit 340, and a control unit 50.

The input unit 310 functions to receive a first input command from a user. The mode activation unit 320 functions to activate a power saving mode (referred herein as a “white screen mode”) to set a display area on a display panel to a white background screen 100 according to the first input command from the input unit 310. In this case, the first input command from a user represents a command to activate a white screen mode of an apparatus for reducing power consumption according to an embodiment of the present invention, and can be input using a hot key.

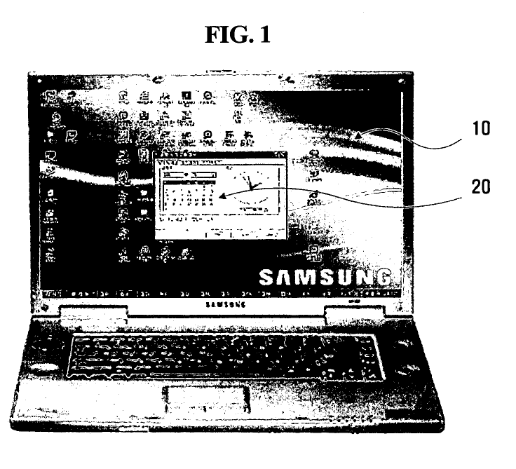

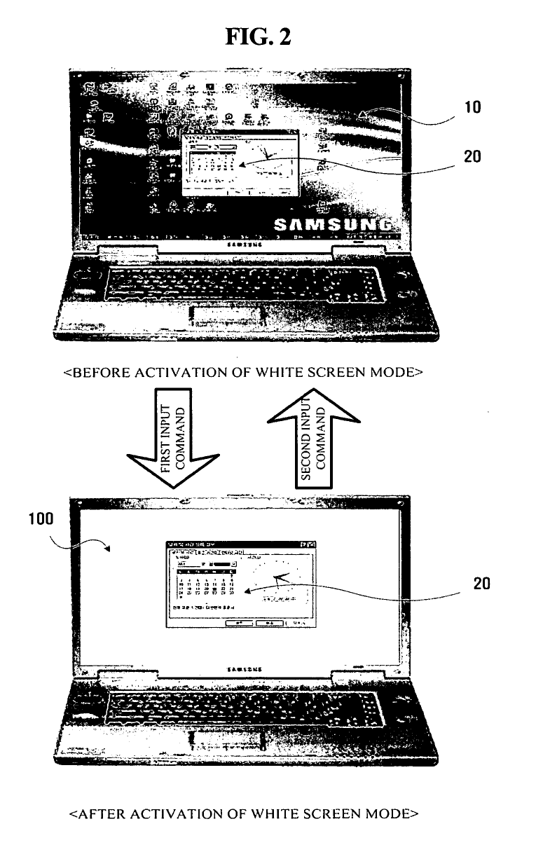

The location setting unit 330 functions to locate the white background screen activated by the mode activation unit 320 to superimpose all windows and display icons, except for a current task window displayed in part of the display area of a display panel. That is, in the state in which the white background screen occupies the entire display area, the current task window is superimposed on the white background screen, as shown in FIG. 2. FIG. 2 is a diagram illustrating a process of operating an apparatus for reducing power consumption in a display area of a display panel according to an embodiment of the present invention. Referring to the view <before activation of white screen mode> located in the upper portion of FIG. 2, it is seen that a plurality of task windows are placed on the task bar existing in the lower portion of the desktop 10, and only one current task window 20, in which a user executes a task, is displayed. This is similar to FIG. 1. However, power is consumed in all areas of the desktop 10, including the area of the desktop 10, which is not used by the user, as well as the area where the current task window 20 is located on a display panel. Therefore, when an apparatus for reducing power consumption according to an embodiment of the present invention is implemented, the state indicated by the view <after activation of white screen mode>, which is located in the lower portion of FIG. 2, is reached. That is, the white background screen 100 covers the entire display area of a display panel, except for the current task window 20, is displayed on the display panel, thereby preventing power consumption in the remaining portion of the display area, other than the current task window 20.

Meanwhile, the location setting unit 330 sets the location of the white background screen 100 and the current task window 20 using z-order values. In particular, the location setting is performed using a method of setting the z-order value of the white background screen 100 to a value lower than the z-order value of the current task window 20 and higher than the z-order values of the remaining covered windows other than the current task window 20.

The storage unit 340 functions to store information about the current task window 20 before the white screen mode is activated by the mode activation unit 320. In this case, the information stored in the storage unit 340 may indicate information about a handle value assigned by an operating system (OS) to the current task window 20, a z-order value, and the size and location of the current task window 20.

Meanwhile, when the white screen mode is deactivated according to a second input command from the user, via the input unit 310, the location setting unit 330 restores information about the current task window 20 and then hides the white background screen 100 again. In this case, the second input command from the user may also be input using the hot key which is used to input the first input command. That is, while the first and second input commands may be executed using separate hot keys, it is preferred that the first and second input commands be executed using the same hot key in a toggle manner.

The control unit 350 functions to control all the above-described units, that is, the input unit 310, the mode activation unit 320, the location setting unit 330 and the storage unit 340.

The term “unit”, as used herein, that is, “module” or “table”, means, but is not limited to, a software or hardware component, such as a Field Programmable Gate Array(FPGA) or Application Specific Integrated Circuit(ASIC), which performs certain tasks. A module may advantageously be configured to reside on the addressable storage medium and be configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Furthermore, the components and modules can be implemented to execute on one or more CPUs in a device.

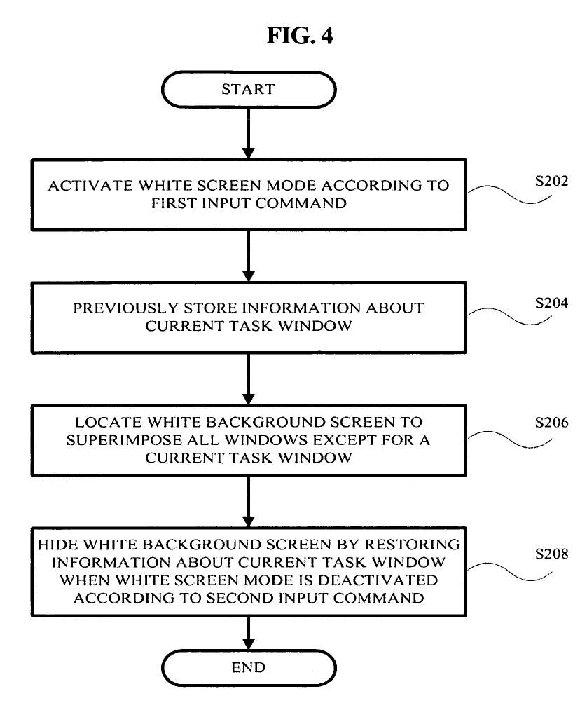

FIG. 4 is a flowchart illustrating a method of reducing power consumption in a display area according to an embodiment of the present invention. Referring to FIG. 4, when a user inputs a first input command, a white screen mode for setting the display area to a white background screen is activated at operation S202. That is, the white screen is in the background state not seen by the user's eyes before the first input command is input, and, is activated at the moment at which the first input command is input, thereby covering the entire display area of a display panel. At this time, the storage unit 340 has previously stored information about the current task window 20 under the control of the control unit 350 at operation S204. In this case, the information, as described above, includes information about a handle value assigned by an operating system to the current task window 20, a z-order value, and the size and location of the current task window 20.

The current task window 20 is then displayed in part of the display area. After the information about the current task window 20 has been stored, the white background screen 100 is located to cover or superimpose all windows and window icons on a display screen of a display panel, except for the current task window 20, and the current task window 20 is superimposed on the white background screen 10 at operation S206. It is preferable to use the z-order values of windows to set locations. In particular, a method of setting the order value of the white background screen 100 to a value which is lower than the z-order value of the current task window 20 and is higher than the z-order values of the remaining covered windows other than the current task window 20 is used.

At a final step, when the white screen mode is deactivated according to the second input command of the user, the white background screen 100 is hidden by restoring information about the current task window 20 at operation S208.

Meanwhile, the first and second input commands can be executed using one or more hot keys. Alternatively, the first and second input commands can be executed using the same hot key in a toggle manner.

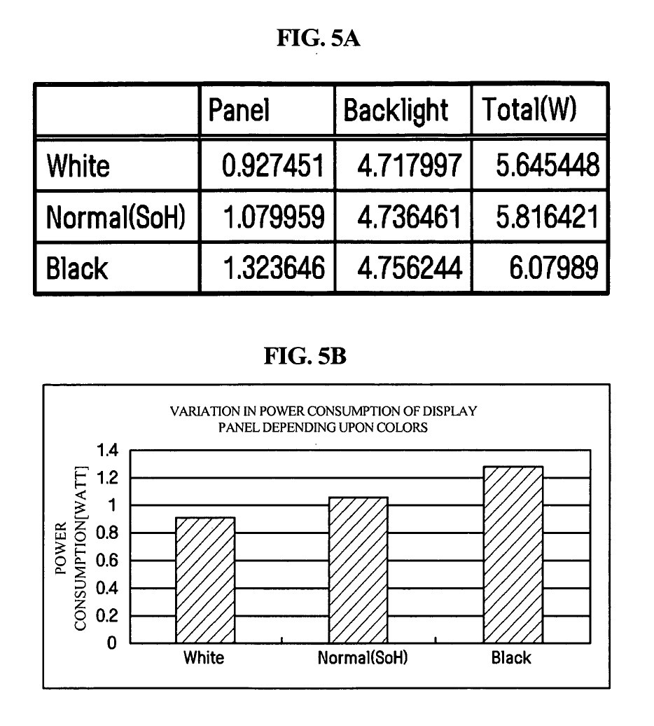

FIGS. 5A-5B are diagrams illustrating the comparison of power consumption depending on the colors of the display area. Referring to the table shown in FIG. 5A, the amounts of power consumption by the display panel and backlight of the display panel are compared with each other for the cases in which the screen colors which are displayed by a display panel are, respectively, white, normal, and black. FIG. 5B illustrates the variation in power consumption of the display panel depending upon colors, such as white, normal and black. As can be seen from FIG. 5B, the power consumption of the backlight does not vary considerably for the colors. However, in the power consumption of the display panel, the power consumption for the case of white is different by about 0.4 watts from that for the case of black. That is, due to the white background screen 100 displayed in the white screen mode activated according to an embodiment of the present invention, the power consumption of the display panel can be reduced.

According to the apparatus and method for reducing power consumption in a display area, there is an advantage of increasing the lifetime of the battery of a portable computer by reducing power consumption in the portion of a display area of a display panel not used by a user.

Various components of the apparatus, as shown in FIG. 3, such as the mode activation unit 320, the location setting unit 330, and the control unit 350 can be integrated into a single control unit, or alternatively, can be implemented in software or hardware, such as, for example, an application specific integrated circuit (ASIC). As such, it is intended that the processes described herein be broadly interpreted as being equivalently performed by software, hardware, or a combination thereof. As previously discussed, software modules can be written, via a variety of software languages, including C, C++, Java, Visual Basic, and many others. These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Instructions of the software routines or modules may also be loaded or transported into the wireless cards or any computing devices on the wireless network in one of many different ways. For example, code segments including instructions stored on floppy discs, CD or DVD media, a hard disk, or transported through a network interface card, modem, or other interface device may be loaded into the system and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

In addition, the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. Alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Furthermore, the software modules as described can also be machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs). Accordingly, it is intended, therefore, that the present invention not be limited to the various example embodiments disclosed, but that the present invention includes all embodiments falling within the scope of the appended claims.

What is claimed is:

1. A method of reducing power consumption in a display area of an electronic device, the method comprising:
activating a mode of setting the display area to a white background screen using a first input command of a user; and
locating the white background screen to cover all windows and window icons on the display area, except for a current task window that is being displayed in part of the display area.

2. The method as claimed in claim 1, further comprising previously storing information about the current task window.

3. The method as claimed in claim 2, wherein the information comprises a handle value, a z-order value, and a size and location of the current task window.

4. The method as claimed in claim 3, further comprising setting a z-order value of the white background screen to a value which is lower than that of the current task window and is higher than the z-order values of remaining windows other than the current task window.

5. The method as claimed in claim 4, further comprising hiding the white background screen by restoring the information about the current task window, when the mode is deactivated by a second input command of the user.

6. The method as claimed in claim 1, wherein the first input command is a command input using a hot key.

7. The method as claimed in claim 5, wherein the second input command is a command input using a hot key.

8. An apparatus for reducing power consumption in a display area of an electronic device, the apparatus comprising:
an input unit;
a mode activation unit arranged to activate a power saving mode of the electronic device to set the display area to a white background screen according to a first input command from a user, via the input unit; and
a location setting unit arranged to locate the white background screen to cover all windows and window icons on the display area, except for a current task window that is being displayed in part of the display area.

9. The apparatus as claimed in claim 8, further comprising a storage unit for previously storing information about the current task window before the power saving mode is activated by the mode activation unit.

10. The apparatus as claimed in claim 9, wherein the information stored in the storage unit comprises a handle value, a z-order value, and a size and location of the current task window.

11. The apparatus as claimed in claim 10, wherein the location setting unit sets a z-order value of the white background screen at a value which is lower than a z-order of the current task window and is higher than z-order values of remaining windows other than the current task window.

12. The apparatus as claimed in claim 11, wherein the location setting unit hides the white background screen by restoring information about the current task window when the power saving mode is deactivated according to a second input command from the user, via the input unit.

13. The apparatus as claimed in claim 8, wherein the first input command is a command input using a hot key.

14. The apparatus as claimed in claim 12, wherein the second input command is a command input using a hot key.

15. A computer-readable recording medium comprising instructions that, when executed by a computer system, perform the method comprising:
activating a power saving mode of the computer system to set a display area of a display panel to a white background screen in response to an input command from a user; and
locating the white background screen to cover all windows and window icons on the display area of the display panel, except for a current task window that is being displayed in part of the display area of the display panel.

16. The computer-readable recording medium as claimed in claim 15, wherein the method further comprises previously storing information about the current task window.

17. The computer-readable recording medium as claimed in claim 16, wherein the information comprises a handle value, a z-order value, and a size and location of the current task window.

18. The computer-readable recording medium as claimed in claim 17, wherein the method further comprises setting a z-order value of the white background screen to a value which is lower than that of the current task window and is higher than the z-order values of remaining windows other than the current task window.

19. The computer-readable recording medium as claimed in claim 16, wherein the method further comprises hiding the white background screen by restoring the information about the current task window, when the power saving mode is deactivated by another input command of the user.

20. The method as claimed in claim 19, wherein the input commands are input, via a hot key.
